(19) United States
(12) Patent Application Publication
(10) Pub. No.: US 2013/0200244 A1
(43) Pub. Date: Aug. 8, 2013

(54) LONGITUDINAL ADJUSTMENT DEVICE WITH A RAIL GUIDE FOR A VEHICLE SEAT

(71) Applicants: Hans-Georg Werner, Langenfeld (DE); Bernd Gross, Langenfeld (DE); Joshua Hesterberg, Mettmann (DE)

(72) Inventors: Hans-Georg Werner, Langenfeld (DE); Bernd Gross, Langenfeld (DE); Joshua Hesterberg, Mettmann (DE)

(73) Assignee: Johnson Controls GMBH

(21) Appl. No.: 13/810,432

(22) PCT Filed: Jul. 13, 2011
(86) PCT No.: PCT/EP2011/061974

§ 371 Date: Mar. 25, 2013

(30) Foreign Application Priority Data
Jul. 16, 2010 (DE) 10 2010 027 480.1

(51) Int. Cl. B60N 2/07

(52) U.S. Cl. CPC B60N 2/07
USPC 248/430; 248/429

(57) ABSTRACT

A longitudinal adjustment device for a vehicle seat includes at least one rail guide with at least one upper rail and a lower rail, wherein the upper rail and lower rail are mounted movably relative to each other via a bearing. A roller cage is provided as the bearing between the upper rail and lower rail, wherein, in the roller cage, rollers are arranged inclined at a predetermined angle with respect to the horizontal plane of the rails or transversely with respect to the running direction of the rails.

The invention relates to a longitudinal adjustment device for a vehicle seat as per the features of the preamble of claim 1 or 11. Furthermore, the invention relates to a vehicle seat comprising such a longitudinal adjustment device with such a rail guide.

Rail guides serve to adjust the seat forward and backward for positioning the occupant. Rails of the rail guide are usually produced from steel. Rails made of aluminum or aluminum alloys are also known, however.

Steel balls are generally used as the rolling bodies. In the case of aluminum profile rails paired with rolling bodies made of steel balls, there is the risk that the steel balls cause instances of deformation in the guide tracks of the rails, i.e. of upper and lower rails (also referred to as brinelling). This so-called brinelling is caused by an excessive contact pressure.

The invention is based on the object of specifying a longitudinal adjustment device which is improved in terms of contact pressure.

With respect to the longitudinal adjustment device, the object is achieved by the features indicated in claim 1 or 11.

Advantageous developments of the invention are the subject of the dependent claims.

The longitudinal adjustment device comprises at least one rail guide with at least one upper and lower rail, which are mounted movably in relation to one another via a bearing, in particular displaceably linearly in relation to one another. According to the invention, provision is made of a roller cage as the bearing between the upper and lower rail, wherein rollers are arranged in the roller cage inclined at a predefined angle in relation to the horizontal plane of the rails or transversely in relation to the running direction of the rails. In other words: instead of conventional steel balls, rollers are used as the rolling bodies. To secure the vehicle seat as required, the upper and lower rail can expediently be locked detachably with respect to one another by a locking mechanism. A bearing in the form of a roller cage with rollers arranged inclined therein and guide tracks resulting therefrom in the upper and lower rail reduce forces which arise and increase the size of the contact surface (linear contact) of the rollers, as a result of which the contact pressure which arises is reduced considerably compared to conventional rail systems with ball bearings.

One possible embodiment provides that the rollers are arranged inclined at an angle in a range of 30° to 60°, in particular of 40° to 50°, in relation to the horizontal plane of the rails or transversely in relation to the running direction of the rails. It is preferable for the rollers to be arranged in the roller cage inclined at an angle of in each case 45° in relation to the horizontal plane of the rails or transversely in relation to the running direction of the rails. This makes an optimum distribution of forces possible.

In one possible embodiment, the rollers are formed as rotatable, elongated solid bodies with a circular, e.g. round, cross section and consist of steel. In particular, the rollers are in the form of circular-cylindrical rollers concentric with respect to the axis of rotation. In a further embodiment, the rollers can have a spherical shape. To this end, the respective roller has varying diameters, in particular diameters which decrease toward the roller ends.

In a further alternative embodiment, the bearing may be in the form of a needle bearing, which comprises needle-shaped, i.e. extremely long and thin, rolling bodies as the rollers. Alternatively, the rollers may have dimensions adapted for the rails and, for example, may be in the form of long rollers with a small diameter or short rollers with a large diameter.

The rollers are arranged in the roller cage alternately offset by 90° in relation to one another. Alternatively, the rollers can be arranged parallel to one another and thus uniformly aligned in the roller cage.

In one development of the invention, the roller cage and the rollers arranged therein are arranged differently depending on the profile cross section of the rail guide, in particular on the open and/or closed profile of the upper and lower rails. A central or concentric position of the roller cage with two external slides, in particular plastic slides, is thus possible, for example. Alternatively, provision may be made of at least two or more roller cages, which are arranged mirror-symmetrically, externally, one above another and/or diagonally or in another arrangement in relation to one another. A further alternative provides a one-sided roller cage with opposing slides, in particular plastic slides. Similarly possible are a double roller with tolerance compensation and also a triple arrangement, i.e. three roller cages, given an asymmetrical profile cross section.

A guide of this type formed from inclined rollers arranged offset in relation to one another leads to a reduction in the permissible contact pressure in the case of rails formed from aluminum. This roller arrangement in combination with guide tracks fitted at 45° both in the upper rail and in the lower rail increases the contact of the rollers, in particular the linear contact. Furthermore, the 45° arrangement brings about a distribution and introduction of forces into the lower rail which is uniform compared to a 90° arrangement, as a result of which stresses in the guide tracks are reduced. Thus, the contact pressure which occurs and instances of mechanical loading which occur and also wear possibly resulting therefrom are reduced considerably compared to the rail systems known to date.

As a result of this, it is possible to use light metal alloys, which have considerably lower material properties (in respect of strengths) than, for example, steel.

To this end, it is provided according to the invention that the upper and lower rails are produced from a different material, one of the rails being produced from a lightweight material, in particular from a light metal alloy and/or a fiber composite material. This makes a particularly light rail structure possible, as a result of which the overall weight of the seat is reduced considerably. Thus, by replacing steel profiles, for example with aluminum profiles, for a rail pair, the weight per rail pair can be reduced by 40% to 50%.

Various embodiments provide that the upper and/or lower rail are or is produced from aluminum, magnesium, steel, an aluminum alloy, a magnesium alloy, carbon fiber reinforced plastic or glass fiber reinforced plastic. In the case of a rail formed from a fiber composite material, it is preferable for at least one reinforcing element, in particular a metallic reinforcing element, e.g. a wire or elements encapsulated by injection molding, to be integrated for increasing the strength and for avoiding brinelling effects. The rails preferably have the integrated reinforcing element in the region of the roller bearing (also referred to as the roller guide). In this case, the reinforcing element can be integrated in the respective rail only over part thereof or over the entire length of the rail only in the region of the roller bearing.

The use of such light metal materials, such as aluminum or magnesium, additionally makes it possible to use extruded profiles, as a result of which the production costs are reduced. In addition, rails with a closed profile can be provided in a simple manner by means of the use of extruded profiles made of aluminum and/or magnesium.

To achieve a light and adequately solid rail structure, it is preferable for one of the rails to be in the form of a closed profile and for the other rail to be in the form of an open profile. In this respect, the two rails are tuned to one another in terms of the materials and/or dimensions and/or shapes used. To this end, one development of the invention provides the use of light metals, such as aluminum and/or magnesium, instead of conventional metal materials as the rail material, as a result of which a rail structure formed from a closed profile and an open profile is made possible. Such a rail structure formed from a closed profile and an open profile provides a compact and light arrangement compared to conventional rail systems with two open profiles. Alternatively, both rails can be in the form of an open profile, in particular a U profile.

To reduce the production costs by increasing the number of identical components, both rails are preferably formed from identical, open profiles.

The invention will be described in more detail with reference to the attached schematic figures, in which:

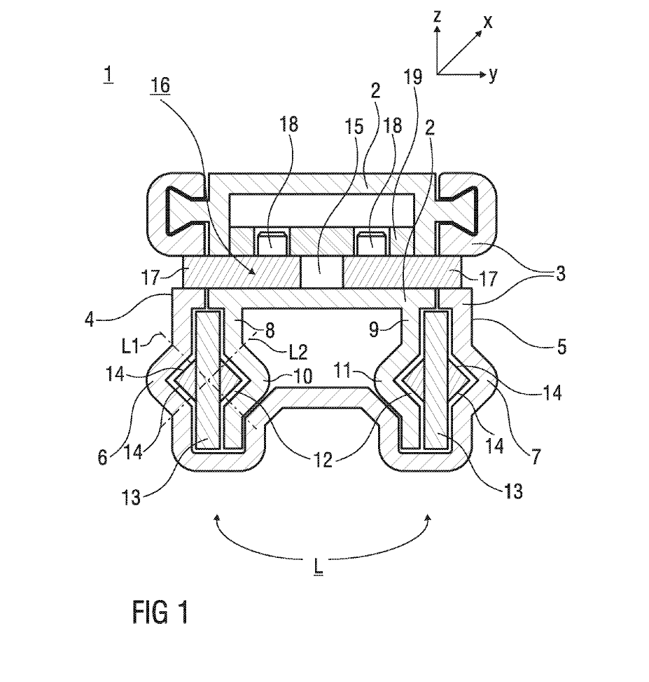

FIG. 1 schematically shows an embodiment of a longitudinal adjustment device in cross section,

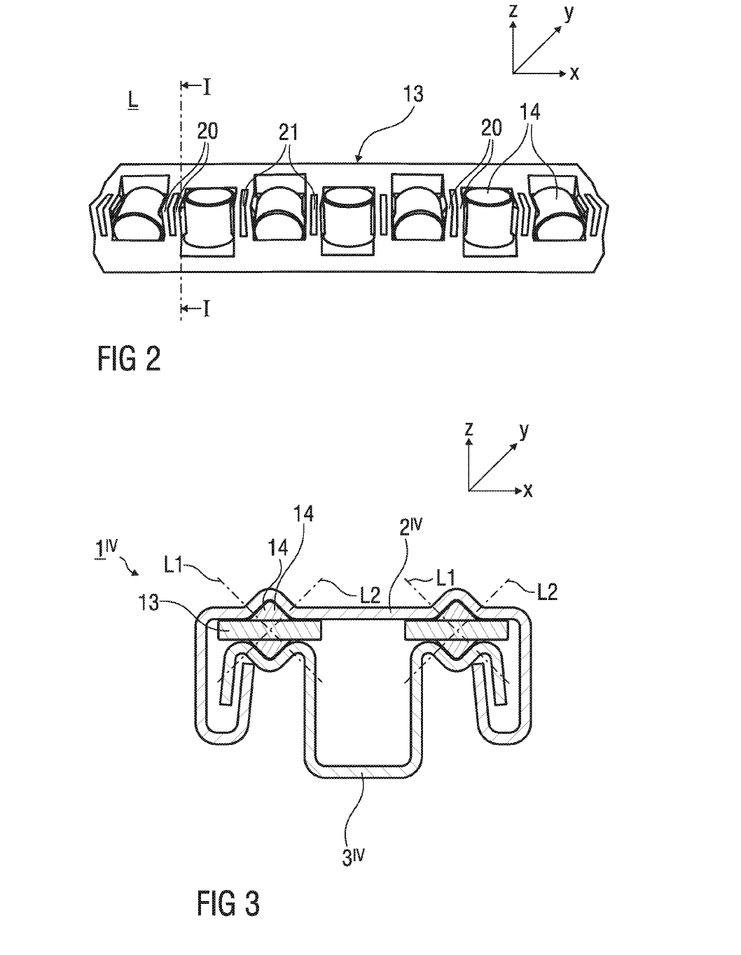

FIG. 2 schematically shows rollers arranged in a roller cage in a perspective illustration,

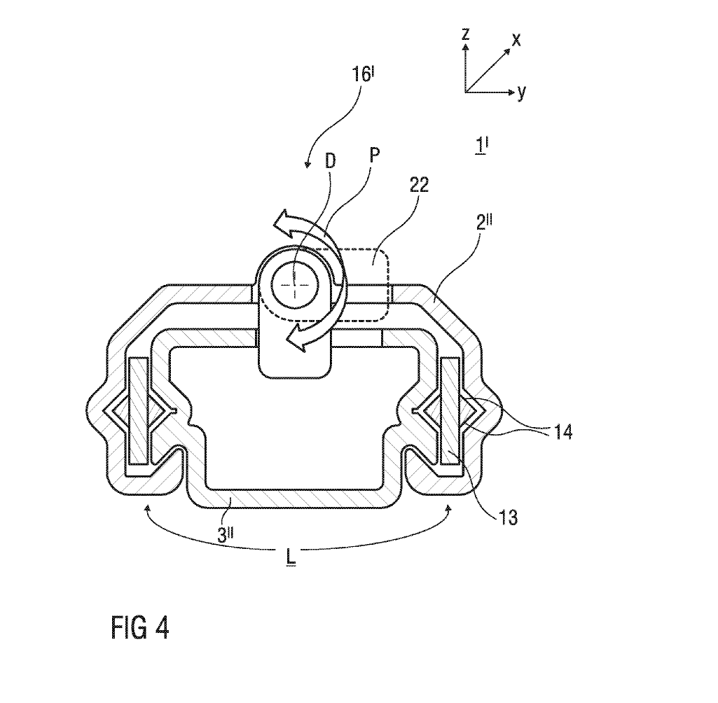

FIG. 3 schematically shows, in cross section, an alternative embodiment of a longitudinal adjustment device with a rail guide, formed from an upper rail and a lower rail, having rollers as the rolling bodies,

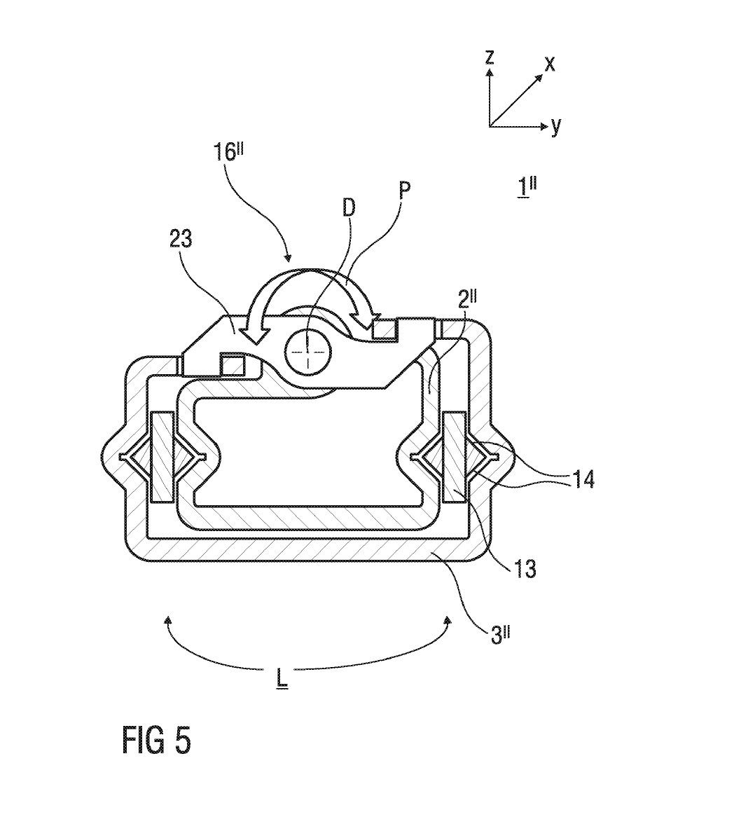

FIG. 4 schematically shows an alternative embodiment of a longitudinal adjustment device with a rail guide having rollers as the rolling bodies,

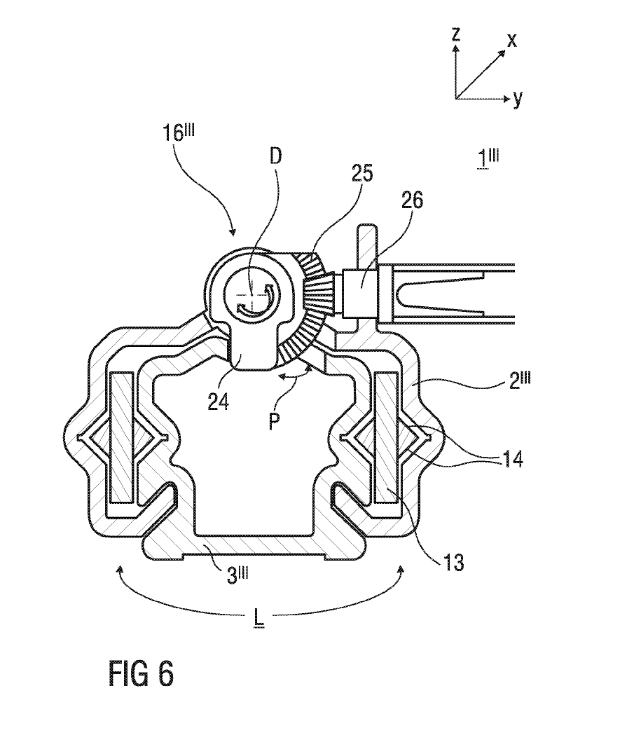

FIG. 5 schematically shows a further alternative embodiment of a longitudinal adjustment device with a rail guide having rollers as the rolling bodies,

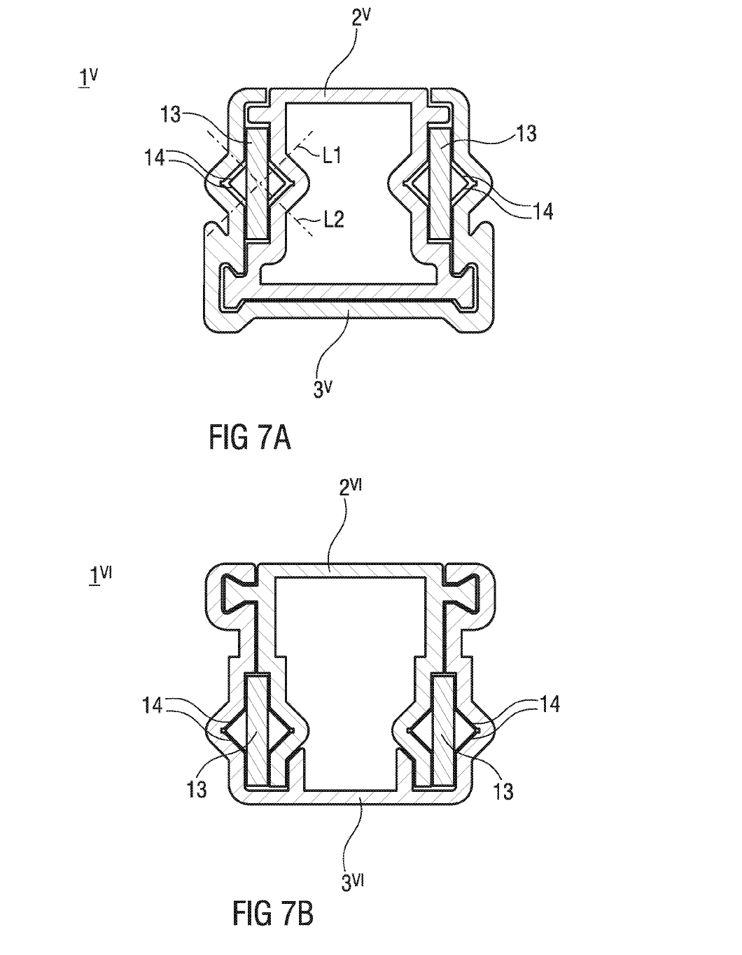

FIG. 6 schematically shows a further alternative embodiment of a longitudinal adjustment device with a rail guide having rollers as the rolling bodies, and

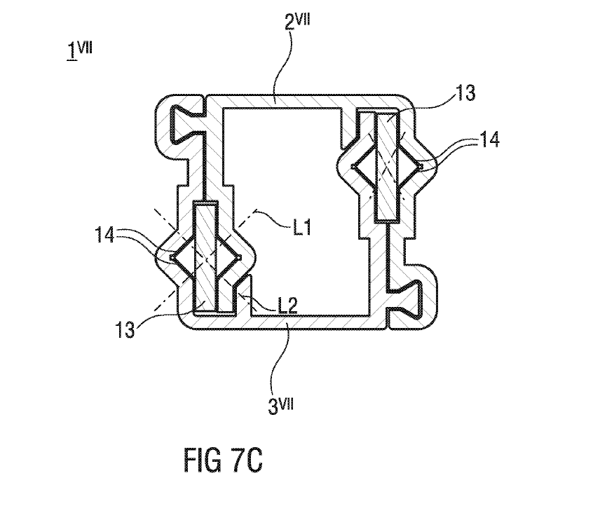

FIGS. 7a to 7c schematically show further alternative embodiments for a longitudinal adjustment device.

Parts which correspond to one another are provided with the same reference signs in all the figures.

FIG. 1 schematically shows, in cross section, an embodiment of a longitudinal adjustment device with a rail guide 1 formed from an upper rail 2 and a lower rail 3. The rail guide 1 serves, for example, as a longitudinal guide for a vehicle seat (not shown in greater detail). In this case, the vehicle seat has, for example, two rail guides 1 for the longitudinal displacement thereof.

In this embodiment shown in FIG. 1, the lower rail 3 encompasses the upper rail 2 laterally and from below. The lower rail 3 has an open profile with a virtually U-shaped profile cross section with two outer legs 4 and 5. The outer legs 4 and 5 of the U profile are provided with formations 6 and 7, respectively, oriented outward away from the upper rail 2.

The upper rail 2 is arranged movably concentrically into the opening of the lower rail 3. The upper rail 2 has a profile cross section with inner legs 8 and 9.

In a manner corresponding to the formations 6 and 7 of the outer legs 4 and 5 of the lower rail 3, the inner legs 8 and 9 of the upper rail 2 have formations 10 and 11, respectively, which lie opposite the formations 6 and 7 and are oriented inward away from the lower rail 3, such that in each case a longitudinal channel 12 is formed for each leg pair 4 and 8 or 5 and 9, the cross section of which longitudinal channel is rectangular, preferably virtually square, the square being arranged symmetrically standing on a corner.

Bearings L of roller cages 13 with rollers 14 as the rolling bodies are arranged in the respective longitudinal channel 12 for longitudinally guiding the rails 2 and 3. The rollers 14 are held in the roller cages 13, which is displaceable, in particular slidable, in the longitudinal channel 12.

The rollers 14 are arranged in the roller cage 13 alternately offset by 90° in relation to one another, such that the rolling face of the rollers 14 runs alternately on the lower face of the formation 7 and the lower face of the formation 11 or the lower face of the formation 6 and the lower face of the formation 10, and in each case roller play is formed in the direction of the upper face of the formation 7 and the upper face of the formation 11 or the upper face of the formation 6 and the upper face of the formation 10. This makes tolerance compensation possible in the radial direction, in particular in the Y and/or Z direction.

This varying arrangement of the rollers 14 is indicated in FIG. 1 by the illustration of the longitudinal axes L1, L2 of the rollers 14.

A notch 15, in which a locking element 16 is arranged, is made in the upper region of the upper rail 2 facing away from the lower rail 3. The locking element 16 has two latching lugs 17, which are arranged such that they can move in relation to one another and engage into recesses (which lie opposite one another and correspond to one another) in the upper rail 2 and the lower rail 3 to lock the latter. In other words: the upper and lower rails 2, 3 can be locked detachably with respect to one another by means of the locking element 16.

To detach the locking and thus to longitudinally displace the rails 2 and 3 in relation to one another, the locking element 16 has pins 18, which protrude upward perpendicularly from the latching lugs 17 and into which an unlocking slide 19 engages. By pushing the unlocking slide 19 in, the latching lugs 17 are moved toward one another, such that they are moved out of the recesses in the upper and lower rail 2, 3, as a result of which a longitudinal displacement of the upper and lower rail 2, 3 is made possible.

By pushing the unlocking slide 19 out, the latching lugs 17 move away from one another, such that they engage into the recesses in the upper and lower rail 2, 3 again and a longitudinal displacement of the latter is blocked. For secure locking of the latching lugs 17 in the recesses in the upper and lower rail 2, 3, the latching lugs 17 are arranged spring-loaded in relation to one another.

FIG. 1 shows the rail guide 1 having an upper and lower rail 2, 3, which have two external guides in the longitudinal channels 12.

FIG. 2 schematically shows, in a perspective illustration, an exemplary embodiment of a roller cage 13 having rollers 14, arranged therein, of a bearing L. The longitudinal axes L1, L2 of the rollers 14 are arranged alternately offset by 90° in relation to one another, such that the latter form two, in particular v-shaped guide tracks. The rollers 14 are arranged in the roller cage 13 inclined by 45° in relation to the main geometry of said roller cage, such that the latter can be arranged standing in the longitudinal channel 12 of the rail guide 1.

As a result of the relatively large contact faces, this reduces the contact pressure which arises considerably, such that brinelling effects are largely avoided.

Alternatively, in a manner which is not shown in greater detail, the rollers 14 can be arranged parallel to one another and thus uniformly aligned in the roller cage 13. In this case, the rollers 14 can be arranged inclined at another predefined angle in relation to the horizontal plane or transversely in relation to the running direction of the rails 2, 3.

Alternatively, the rollers 14 can be arranged in the roller cage 13 inclined at an angle in a range of 30° to 60°, in particular of 40° to 50°.

For a substantially symmetrical design of the roller cage 13 and of the longitudinal channel 12, with a virtually square cross section, the rollers 14 have a length which corresponds substantially to the diameter of the rollers 14. However, they can also have other dimensions. By way of example, the rollers can have a length which is greater than their diameter. The rollers can also have a spherical shape, in which case the rollers have a varying diameter, in particular diameters which decrease toward the roller ends.

The rollers 14 are arranged in the roller cage 13 separated from one another by partition walls 20 and are mounted rotatably in chambers 21 which result therefrom.

The rollers 14 consist of steel and are therefore inexpensive. Coated steel rollers can also be used for reducing or avoiding contact corrosion. Alternatively, these may be formed from plastic or fiber reinforced plastic, and therefore no contact corrosion occurs. In a further alternative, the rollers 14 may also be formed from a soft plastic, as a result of which the rollers 14 have a damping and tolerance-compensating action.

The rollers 14 are formed as cylinder rollers and form, arranged in the roller cage 13, a cylinder roller bearing for guiding the rails 2 and 3.

Alternatively, the rollers 14 may be in the form of so-called needle rollers and the bearing L may be in the form of a needle bearing.

The various material implementations and/or contours and/or cross sections of the rollers 14 which are described herein can be used for all alternative longitudinal adjustment devices described hereinbelow.

The roller cage 13 preferably consists of plastic, in particular of a polymer.

The bearing L can additionally be formed in such a manner that, in a manner not shown in greater detail, the rollers are arranged in the roller cage inclined at a predefined angle in particular of in each case 45° transversely in relation to the running direction of the rails. A further alternative, which is not shown, provides that the roller cage and the rollers arranged therein are arranged differently depending on the profile cross section of the rail guide, in particular on the cross section or profile of the upper and lower rail. A central or concentric position of the roller cage with two external slides, in particular plastic slides, is thus possible, for example. Alternatively, provision may be made of two roller cages, which are arranged mirror-symmetrically, externally and/or diagonally in relation to one another. Further alternatives provide a one-sided roller cage with opposing plastic slides or a double roller with tolerance compensation. A multiple, in particular a triple, arrangement, i.e. three roller cages, given an asymmetrical profile cross section are also possible.

FIG. 3 schematically shows an alternative longitudinal adjustment device with a rail guide 1^{IV}, the upper and lower rail 2^{IV}, 3^{IV} each being formed as an open profile. In this case, the upper and lower rail 2^{IV}, 3^{IV} have guide tracks running parallel to one another on the top sides thereof, the roller cages 13 being arranged in hollow spaces formed by convexities in the rails 2^{IV}, 3^{IV}, such that they are arranged in parallel alongside one another in the region of the top side of the rail guide 1^{IV}.

For secure guidance of one of the rails 2^{IV}, 3^{IV}, in particular of the upper rail 2^{IV}, on the other, stationary rail, in particular the lower rail 3^{IV}, the upper rail 2^{IV} encompasses the lower rail 3^{IV}.

The described upper and lower rails 2, 3 or 2^{IV}, 3^{IV} and the rails 2^{I} to 2^{III}, 3^{I} to 3^{III} of the alternative embodiments hereinbelow may be produced from a different material, one of the rails being formed from a lightweight material, in particular from a light metal alloy and/or a fiber composite material, in particular glass fiber reinforced or carbon fiber reinforced plastic with or without a reinforcing element. The reinforcing element is in this case preferably integrated into the rails 2, 3 in the region of the bearing L. If the rails 2, 3 produced from a lightweight material are provided with such a reinforcing element, it is also possible for a ball bearing to be used instead of a roller bearing.

The rails can be produced from light metal sheets made, for example, of aluminum or magnesium and/or steel sheets or other light metal alloys. The rails are preferably produced from extruded profiles.

To achieve a sufficient strength of the longitudinal adjustment device if at least one of the rails 2^{I to IV}, 3^{I to IV} is made of a lightweight material, these have different profile cross sections, in particular one of the rails 2^{I to IV}, 3^{I to IV} has a closed profile and the other rail 2^{I to IV}, 3^{I to IV} has an open profile which encompasses the closed profile.

FIGS. 3, 4 and 6 in this respect show an arrangement of the upper rail 2^{IV}, 2^{I}, 2^{III} with an open profile, in particular a profile open on one side, which covers the respective lower rail 3^{IV}, 3^{I}, 3^{III} with a closed profile and thus the inner space.

FIG. 4 schematically shows an alternative embodiment of a longitudinal adjustment device with an alternative rail guide 1^{I} having rollers 14 as the rolling bodies.

The bearing L consisting of the rollers 14 and the roller cage 13 is formed analogously to the embodiment shown in FIGS. 1 and 2.

The rail guide 1^{I} differs from the rail guide 1 shown in FIG. 1 in an alternative cross-sectional shape of the rails 2^{I} and 3^{I} and, resulting therefrom, an alternative shape of a locking element 16^{I}.

The lower rail 3^{I} is formed as a hollow profile body, on which a substantially U-shaped upper rail 2^{I} is arranged at least partially encompassing the lower rail 3^{I}.

The locking element 16^{I} is formed as a rotary arm 22, which is mounted such that it can rotate about an axis of rotation D in the upper rail 2^{I}. By corresponding rotation of the rotary arm 22 in the direction of the arrow P, the rotary arm 22 engages into a recess in the lower rail 3^{I}, such that the two rails 2^{I} and 3^{I} are blocked. By rotation of the rotary arm 22 in the opposite direction, the latter is held in a recess in the upper rail 2^{I} in such a manner that the rails 2^{I} and 3^{I} are displaceable in relation to one another.

FIG. 5 schematically shows a further alternative embodiment of a longitudinal adjustment device with a rail guide 1^{II} having rollers 14 as the rolling bodies.

The lower rail 3^{II} (=outer rail) is formed substantially as an open U-shaped, stationary rail profile, in which the upper rail 2^{II} (=inner rail) in the form of a closed hollow profile body is movably arranged.

The locking element 16^{II} is formed as a two-arm rotary lever 23, which is mounted such that it can rotate about an axis of rotation D in the lower rail 3^{II}. By corresponding rotation of the rotary lever 23 in the direction of the arrow P, the rotary lever 23 engages into recesses in the upper rail 2^{II}, such that the two rails 2^{II} and 3^{II} are blocked. By rotation of the rotary lever 23 in the opposite direction, the latter is moved out of the recesses and held in such a manner that the rails 2^{II} and 3^{II} are displaceable freely in relation to one another.

FIG. 6 schematically shows a further alternative embodiment of a longitudinal adjustment device with a rail guide 1^{III} having rollers 14 as the rolling bodies.

The lower rail 3^{III} is formed as a closed hollow profile body, on which a substantially open, U-shaped upper rail 2^{III} is arranged, at least partially encompassing the lower rail 3^{III}.

The locking element 16^{III} is formed as a rotary hook 24, which is mounted in the upper rail 2^{III} such that it can rotate about an axis of rotation D by means of a bevel wheel 25.

The bevel wheel 25 is driven by a shaft 26. By corresponding rotation of the bevel wheel 25, the rotary hook 24 is turned in the direction of the arrow P, as a result of which the rotary hook 24 engages into a recess in the lower rail 3^{III}, such that the two rails 2^{III} and 3^{III} are blocked. By rotation of the rotary hook 24 in the opposite direction, the latter is moved out of the recess in the lower rail 2^{III} and held in such a manner that the rails 2^{III} and 3^{III} are displaceable freely in relation to one another.

FIGS. 7A to 7C show further alternative embodiments for a longitudinal adjustment device.

FIG. 7A shows a rail guide I^{V} with an upper rail 2^{V}, in the form of a movable inner rail with a closed profile, and a stationary lower rail 3^{V}, in the form of an outer rail with an open, u-shaped profile. In this case, the roller cages 13 are arranged lying opposite one another in the longitudinal sides of the rail guide 1^{V}.

FIG. 7B shows a further alternative rail guide 1^{VI}. Here, both rails 2^{VI}, 3^{VI} are in the form of open, u-shaped profiles, these being arranged with the open end facing one another and thus in one another. The roller cages 13 are arranged lying opposite one another in the longitudinal sides of the rail guide 1^{VI}.

FIG. 7C shows a further alternative rail guide 1^{VII}. The two rails 2^{VII} and 3^{VII} are identical open, u-shaped profiles, which are arranged inserted into one another. The roller cages 13 are arranged lying diagonally opposite one another in the longitudinal sides of the rail guide 1^{VII}.

### LIST OF REFERENCE SIGNS

1, 1^{I} to 1^{VII} Rail guide
2, 2^{I} to 2^{III} Upper rail
3, 3^{I} to 3^{III} Lower rail
4 Outer leg of the lower rail
5 Outer leg of the lower rail
6 Formation in the lower leg 4 of the lower rail
7 Formation in the lower leg 5 of the lower rail
8 Inner leg of the upper rail
9 Inner leg of the upper rail
10 Formation in the inner leg 8 of the upper rail
11 Formation in the inner leg 9 of the upper rail
12 Longitudinal channel
13 Roller cage
14 Rollers
15 Notch
16, 16^{I} to 16^{III} Locking element
17 Latching lugs
18 Pins
19 Unlocking slide
20 Partition walls
21 Chambers
22 Rotary arm
23 Rotary lever
24 Rotary hook
25 Bevel wheel
26 Shaft
L1, L2 Longitudinal axis
L Bearing
P Arrow
D Axis of rotation

1. A longitudinal adjustment device for a vehicle seat, comprising at least one rail guide with at least one upper rail and a lower rail, wherein the upper rail and the lower rail are mounted movably in relation to one another via a bearing,
wherein a roller cage is provided as the bearing between the upper rail and the lower rail, wherein rollers are arranged in the roller cage inclined at a predefined angle in relation to the horizontal plane of the rails or transversely in relation to the running direction of the rails.

2. The longitudinal adjustment device as claimed in claim 1, wherein the rollers are arranged inclined at an angle in a range of 30° to 60°, in relation to the horizontal plane of the rails or transversely in relation to the running direction of the rails.

3. The longitudinal adjustment device as claimed in claim 1, wherein a sequence of rollers are arranged in the roller cage as rotatable, elongated rolling bodies with a circular cross section and/or with varying diameters.

4. The longitudinal adjustment device as claimed in claim 1, wherein the bearing is in the form of a needle bearing, which comprises needle-shaped rolling bodies as the rollers.

5. The longitudinal adjustment device as claimed in claim 1, wherein the rollers are arranged in the roller cage alternately offset by 90° in relation to one another.

6. The longitudinal adjustment device as claimed in claim 1, wherein the rollers are arranged in the roller cage parallel to one another.

7. The longitudinal adjustment device as claimed in claim 1, wherein that the roller cage and the rollers arranged therein are arranged differently depending on the profile cross section of the rail guide.

8. The longitudinal adjustment device as claimed in claim 7, comprising a central or concentric position of the roller cage with two external slides.

9. The longitudinal adjustment device as claimed in claim 7, comprising at least two roller cages, which are arranged mirror-symmetrically, externally, one above another and/or diagonally in relation to one another.

10. The longitudinal adjustment device as claimed in claim 7, comprising a one-sided roller cage with opposing slides, in particular plastic slides.

11. A longitudinal adjustment device for a vehicle seat, comprising at least one rail guide with at least one upper rail and a lower rail, wherein the upper rail and the lower rail are mounted movably in relation to one another via a bearing,
wherein the upper and lower rails are produced from a different material, one of the rails being formed from a lightweight material.

12. The longitudinal adjustment device as claimed in claim 11, wherein the upper and lower rails are produced from the same lightweight material.

13. The longitudinal adjustment device as claimed in claim 11, wherein the upper and/or lower rail are or is produced from aluminum, magnesium, steel, an aluminum alloy, a magnesium alloy, carbon fiber reinforced plastic or glass fiber reinforced plastic.

14. The longitudinal adjustment device as claimed in claim 11, wherein the one rail is formed from a fiber composite material, and at least one reinforcing element, is integrated therein.

15. The longitudinal adjustment device as claimed in claim 11, wherein one of the rails is in the form of a closed profile and the other rail is in the form of an open profile.

16. The longitudinal adjustment device as claimed in claim 11, wherein both rails are in the form of an open profile.

17. The longitudinal adjustment device as claimed in claim 16, wherein both rails are formed from identical or mirror-symmetrical open profiles.

18. A vehicle scat having a longitudinal adjustment device as claimed in claim 1.
